(19) United States
(12) Patent Application Publication
(10) Pub. No.: US 2016/0005109 A1
(43) Pub. Date: Jan. 7, 2016

(54) BUSINESS METHOD FOR EFFICIENT AND DIRECT BUYING, SELLING RENTING AND LEASING REAL ESTATE

(71) Applicant: Joseph Michael, Los Angeles, CA (US)

(72) Inventor: Joseph Michael, Los Angeles, CA (US)

(21) Appl. No.: 14/323,899

(22) Filed: Jul. 3, 2014

(51) Int. Cl. G06Q 30/06; G06Q 30/08

(52) U.S. Cl. CPC G06Q 30/0645; G06Q 30/08; G06Q 50/16

(57) ABSTRACT

Disclosed herein are methods of selling or leasing real estate within a computer-based membership club, comprising the steps of: a) establishing a real estate membership club on a website on a computer-based network, wherein the membership club comprises at least one customer member, at least two owner members, and optionally at least one credit evaluation entity; b) on the website, accepting a real estate application package from the customer member; c) on the website, providing access to the real estate application package to the at least two owner members; d) on the website, accepting a bid from each of the owner members; e) on the website, providing access to the bids to the customer member; f) on the website, accepting the customer member's selection of the offer bid and g) on the website, completing and closing the sale or lease transaction.

### FIELD OF THE INVENTION

The presently disclosed methods relate to computer-based membership clubs designed to increase the volume and efficiency of buying, selling, renting and leasing real estate between buyers and sellers; lessors or landlords and lessee or tenants.

### BACKGROUND OF THE DISCLOSURE

Traditionally, real estate transactions, including leasing, renting, selling and buying are processed and closed between various potential players, including, among others, a buyer, seller, appraiser, property owner, environmental company, prospective tenant, financial entity or lender, loan broker, real estate broker, leasing agent, escrow officer, title company and an attorney.

Currently, there are numerous websites available to supplement real estate sales, leasing and marketing. In particular, there are intermediary entities like Auction.com, Loopnet.com, Costar.com and Zillow.com. Then, there are direct websites such as, MLS.com; CBRE.com and NAICapital.com, whereby sellers and buyers can access the real estate listing inventory and information without an intermediary like those previously discussed.

In this aspect, these online sites and companies have substantial information available including inventory for real estate assets for sale or lease. However, none of these sites make it possible for property owners to submit a direct offer or a bid to a buyer or to a tenant. Therefore, there is a market need for a computer-based network as part of a membership club that enables sellers and property owners to directly offer a sale or leasing bid directly to the buyer or tenant, in response to needs and requirements of a buyer and lessee/tenant, with access to potential buyer's and lessee's/tenant's qualifications.

### SUMMARY OF THE INVENTION

Disclosed herein are methods of selling or leasing real estate within a computer-based membership club, comprising the steps of: a) establishing a real estate membership club on a website on a computer-based network, wherein the membership club comprises at least one customer member, at least two owner members, and optionally at least one credit evaluation entity; b) on the website, accepting a real estate application package from the customer member; c) on the website, providing access to the real estate application package to the at least two owner members; d) on the website, accepting a bid from each of the owner members; e) on the website, providing access to the bids to the customer member; f) on the website, accepting the customer member's selection of the offer bid and g) on the website, completing and closing the sale or lease transaction.

### BRIEF DESCRIPTION OF THE DRAWINGS

FIG. 1 is a flowchart depicting the real estate buying, selling and leasing marketplace of the membership club.

FIG. 2 is an illustration of the computer-based network depicting the flow of information within the membership club between buyer members, Tenant members, Selling members and Landlord members over the internet.

### DETAILED DESCRIPTION OF THE EMBODIMENTS

The following is a detailed description of certain specific embodiments of the methods disclosed herein. In this description reference is made to the drawings. For convenience the present disclosure is organized stepwise in a way that corresponds approximately to the steps in the buying, selling, renting and leasing real estate method herein.

Disclosed herein are methods that relate to computer-based membership clubs comprising a computer-based network; and two or more of sellers, buyers, lessors or landlords, and lessees or tenants. This computer-based membership club optionally also includes real estate brokers, escrow and title company and membership club employees. The membership club employs membership club employees that are professionally trained to establish qualification for buying members or lessees/tenant members and thus provide selling members or landlord/lessors the ability to provide a bid in response to, and based on, the needs and requirements of a buying member or lessees/tenant member, thus marking real estate transactions more competitive, direct and efficient between the parties.

### Definitions

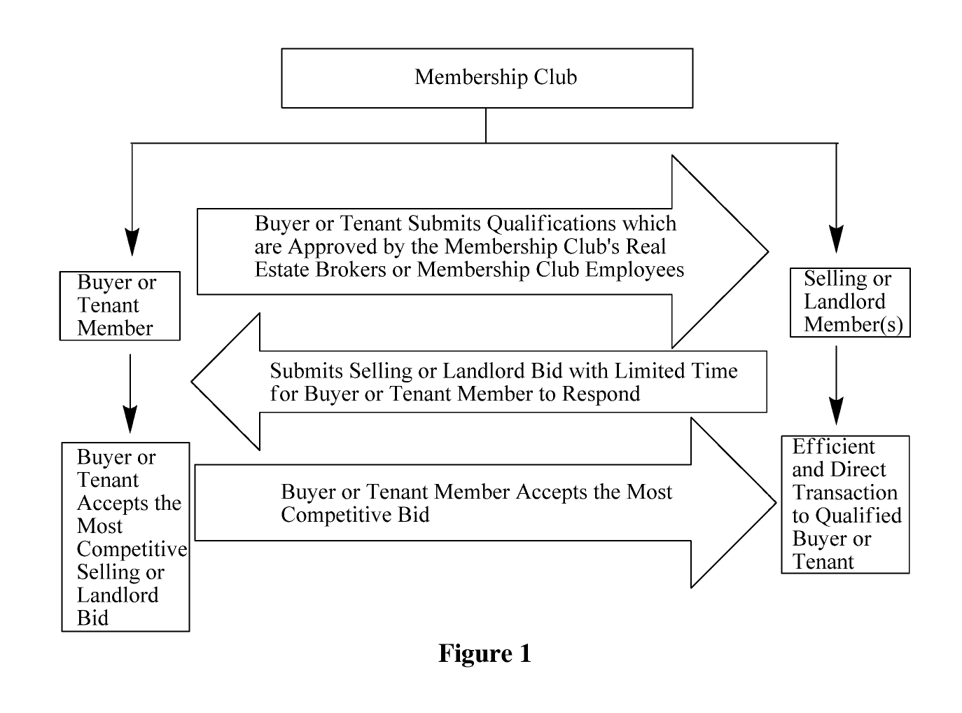

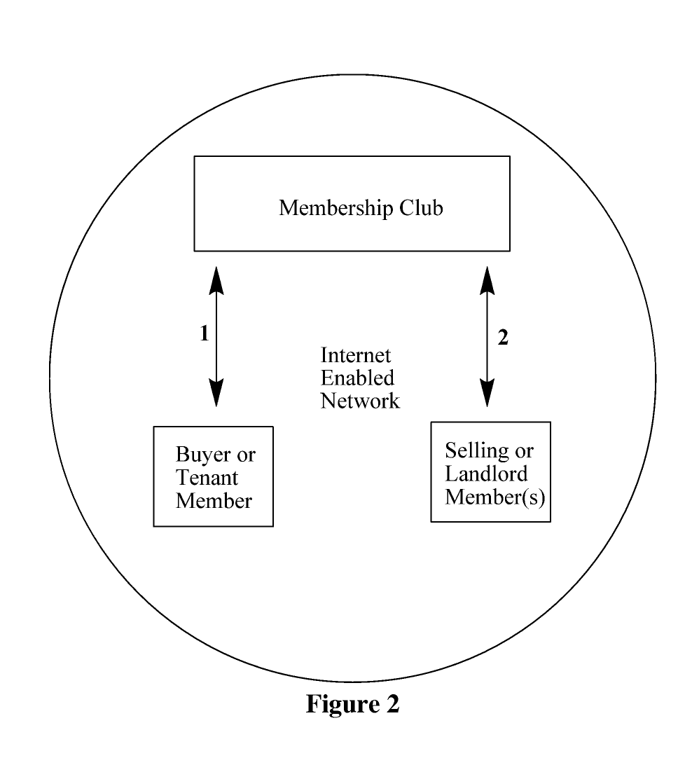

The term “customer member”, refers to an individual, group, corporate entity or other business, or a government institution that is a member of the membership club herein and is interested in buying, renting, or leasing real estate. With reference to the flow chart of FIG. 1 and then illustration of FIG. 2, as discussed fully below, in some embodiments, the customer member is a Buyer member, who is interested in purchasing real estate. In other embodiments, the customer member is a Tenant member, who is interested in renting or leasing real estate. Unless specified otherwise, the methods disclosed herein are similar for both Buyer and Tenant members.

The term “owner member”, refers to an individual, group, corporate entity or other business, or a government institution that is a member of the membership club herein, who owns a piece of real estate, or is an agent of an entity who owns a piece of real estate, and is interested in selling, renting out, or leasing out the piece of real estate. With reference to the flow chart of FIG. 1 and then illustration of FIG. 2, as discussed fully below, in some embodiments, the owner member is a Selling member, who is interested in selling real estate. In other embodiments, the owner member is a Landlord member, who is interested in renting out or leasing out real estate. Unless specified otherwise, the methods disclosed herein are similar for both Selling and Landlord members.

The term “real estate application package,” refers to the required documentation that the customer member submits to the membership club to identify the requirements of the real estate the customer member is interested in obtaining, either by buying, renting, or leasing.

The term “qualification package,” refers to the required documentation and verification information that the customer member submits to the membership club to establish qualification for the membership club's evaluation entity. In some embodiments, the qualification package is optional. In the embodiments where the qualification package is obtained, ultimately the qualification information may be used by owner members to submit a competitive bid to the customer member. The information is evaluated to measure the customer member's credit worthiness and qualifications to purchase or lease properties. For example, these requirements within residential real estate transaction may include the following:
Credit Report.
Income/employment verification
   Verification of Deposit (VOD) showing average balances for a period of time, for example two months.
   Bank statements.
   Gift letter.
   Other—Documentation to evidence other assets, as applicable.
Underwriting Report.
Other information pertinent to qualification and credit worthiness.

The term “evaluation” refers to a detailed credit analysis preceding the lease or sale transaction. This report is based on credit information furnished by the customer member. This form of underwriting pertains to, for example, which includes the verification of such items as employment history, salary and financial statements; publicly available information, such as customer member's credit history, which is detailed in a credit report; and the membership club's evaluation of the customer member's credit needs and ability to make its lease payments or close a sales transaction. Other examples of business underwriting for a customer member may include commercial or business underwriting consists of the evaluation of financial information provided by businesses including analysis of the business balance sheet including tangible net worth, the ratio of debt to worth and available liquidity, number of employees and business plan. Analysis of the income statement typically includes the revenue, gross margin, and profitability.

The term “credit evaluation entity” refers to the entity that conducts the credit evaluation, which is a part of membership club.

The term “credit application evaluation results” refers to the evaluation of the customer member's credit worthiness by the credit evaluation entity.

The term “completed qualification package” refers to a file containing, among others, one or more of the real estate application package, the qualification package, and the credit application evaluation results. The completed application package is the information that is available to the owner members. The owner members base their bids on the information contained in the completed qualification package.

The term “bid” refers to the bid by an owner member. For example the bid to lease an office space made by an owner member includes two or more of the following: the lease terms, including lease rate, the location of the property, the area (in square feet or square meters) of the property, the configuration of the property (for example, the location of the rooms or offices, location of hallways, location of kitchenette or utility rooms, etc.), the building amenities (for example mail service, security, computer network service, etc.), a video of the space, pictures, tenant improvements offered by the owner member and conditions of delivery of the space to the customer member and the like. By way of another example, the bid to sell an industrial building by an owner member includes two or more of the following: Sales price, terms and conditions to close the transaction (for example: all cash or 20% down, 80% financed), copies of all lease agreements and documents encumbering the property and the required time-frame for closing the transaction. These bids are made by the owner members through the membership club to the customer members.

The term “computer-based network”, refers to a telecommunications network that allows computers to exchange data. In this aspect, networked computing devices may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of a computer network. Two such devices are said to be networked together when one device is able to exchange information with the other device, whether or not they have a direct connection to each other. The best-known computer network is the Internet. Computer networks support applications such as access to the World Wide Web and the Cloud, shared use of application and storage servers, printers, and fax machines, and use of email and instant messaging applications.

The term “selling bid”, refers to a bid from the owner member for the sale of a property.

The term “leasing bid”, refers to a bid from the owner member for the leasing out or renting out a property.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Introduction

In one aspect, disclosed herein are methods of selling or leasing real estate within a computer-based membership club, comprising the steps of:
a) establishing a real estate membership club on a website on a computer-based network, wherein the membership club comprises at least one customer member, at least two owner members, and optionally at least one credit evaluation entity;
b) on the website, accepting a real estate application package from the customer member;
c) on the website, providing access to the real estate application package to the at least two owner members;
d) on the website, accepting a bid from each of the owner members;
e) on the website, providing access to the bids to the customer member;
f) on the website, accepting the customer member's selection of the offer bid and
g) on the website, completing and closing the sale or lease transaction.

In some embodiments, the above method further comprises, after step b), the step of, on the website, providing access to real estate application package to the credit evaluation entity, and receiving the credit application evaluation results from the credit evaluation entity.

In some embodiments, the above method further comprises, after step c), the step of, on the website, creating a completed application file, comprising the real estate application package and the credit application evaluation results, and providing access to the completed application file or qualification package to the at least two owner members.

In some embodiments, a list of required qualification information including required documents is provided on the computer-based network by the credit evaluation entity. To become a member and start the process for receiving bids from the owner members, the customer member provides at least the documents enumerated in the list along with the real estate application package. These documents include all the information necessary to determine the credit worthiness of the customer member.

In some embodiments, the customer member also includes the customer member's requirements and criteria for the property the customer member is seeking to lease or buy. For example, the customer member includes information as to the desired location of the property, the area (in square feet or square meters) of the property, the configuration of the property (for example, the location of the rooms or offices, location of hallways, location of kitchenette or utility rooms, etc.), the building amenities (for example mail service, security, computer network service, etc.), and the like. In some embodiments, the customer member also includes the maximum purchase price in case of a sale or the desired lease term or maximum rental rate or monthly lease payments.

In some embodiments, the credit application evaluation results are based on credit reports, income or any other documentation needed to close the sale or the lease.

In some embodiments, qualification package and/or the real estate application package for each customer member is stored electronically within the computer-based network with the membership club and can be accessed and updated in one or more successive transactions. Thus, a customer member may submit one package for a first transaction, and then update the package as to the customer member's property requirements, qualification and credit information, such as income, liquid assets, or changed needs for any subsequent transactions, if desired. A customer member who wishes to lease or purchase several properties, therefore, need not submit a new package for each transaction. In some embodiments, the customer member is provided unlimited opportunity to update the package, where the updating comprises replacing outdated information stored electronically within the computer-based network with the membership club.

In some embodiments, the qualification evaluation results further comprise a qualification rating between about 1 to 10, where a rating of 10 represents a better qualified customer member applicant than a rating of 1. Scales having other values, for example 0 to 1, 1 to 100, 1 to 1000, and the like are also contemplated. In some embodiments, certain owner members would only entertain applications that have received a high rating, for example a rating of 8 and above, whereas other owner members entertain customer members that have a lower rating, for example 5 and above. Each owner member can then decide which qualification it entertains when matching its risk criteria with the qualification rating.

In some embodiments, the bid further comprise all the terms and conditions required to close a sale or lease transaction.

In some embodiments, the membership club comprises at least 1, 2, 3, 4, 5, 6, 7, 8, 9 or 10 different owner members and each owner member submits at least 1, 2, 3, 4, 5, 6, 7, 8, 9 or 10 different bids, wherein the membership club provides for a competitive bidding platform on the website. Pursuant to the competitive bidding platform, the customer member receives bids from different owner members regarding different properties. For example, a single owner member may have two or more different properties that would suit the needs of the customer member. Such owner member may submit a single bid for each of the properties. The owner members are not privy to the offers by other owner members. The customer member receives bid(s) and within a finite amount of time, as required, selects and accepts a desired bid. In some embodiments, the amount of time is less than about 7 days, 14 days, 21 days or 28 days. Once the customer member selects a desired bid, the customer member is obligated to close the selected sale/lease transaction.

In some embodiments, the membership club further comprises a communication platform on the website that allows owner members to advertise the bids to customer members or vice versa (customer members advertise their criteria to the owner members). In certain embodiments, the communication platform comprises a method of communication selected from the group consisting of mobile phone text messaging, telephone voice messaging, email and instant messaging over the computer-based network.

In some embodiments, the disclosed methods further comprise the steps of processing the selling and leasing transactions in compliance with state and federal regulations.

FIG. 1 illustrates an embodiment of the disclosed membership club that is capable of utilizing the disclosed method for improving the efficiency and volume of selling and buying real estate, or renting and leasing transactions. The disclosed method can be used by or in connection with an owner member as an individual, group, corporate entity or other business, or a government institution that is a member of the membership club herein and is interested in selling or leasing out real estate. The method illustrated in FIG. 1 includes a customer member as an individual, group of individuals, corporate entity or other business, or a government institution. Moreover, the method illustrated in FIG. 1 employs a membership club, whereby sellers, property owners, buyers and Tenants become members of the club.

When a potential real estate buyer or tenant becomes a customer member, it submits its acquisition or lease criteria to purchase or lease real property to the membership club. The customer member may, although not mandatory, establish their qualification with the membership club, which may include a range of their financial and credit profiles, including relevant company or individual information. The membership club then submits a qualification package either in a form of a summary or a complete qualification file to various owner members. These owner members then submit a bid via the membership club to the customer member. The credit and financial information may help the customer member receive better bids from the sellers or landlords of real properties, who are owner members. Property owners who wish to lease or sell real properties will also become members as owner members. Based on the criteria received through the membership club from customer members, owner members submit time limited bids to customer members. Finally, a customer member accepts the most competitive bid. The transaction based upon the terms of the best bid is finalized through the membership club. This represents a closed bid format where the owner member submits its best bid in order to close a transaction without knowing bids from other owner members. With this method the membership club provides the customer members with the most competitive bid, with the most attractive terms or sales price or lease terms and lease rates, and with owner members having the biggest desire to sell or lease, thus creating a greater advantage of closing a sale or lease transaction. Therefore, the most competitive owner members will have an advantage in efficiently completing the sale or leasing of properties in the marketplace, while the customers benefit from competition between owner members.

In FIG. 2, Pathway 1 shows transmitting qualification information and desired real estate particulars to the membership club and receiving selling bids or leasing bids from the owner members via the membership club. Pathway 2 shows receiving qualification profiles from customer members. The qualification profiles are available in membership club to the qualified owner members and used in the transmission of selling bids or leasing bids to the customer members via the membership club.

Currently, there are numerous websites positioned for real estate sales and leasing. In particular, there are intermediary entities like Auction.com, Loopnet.com, Costar.com, Zillow.com and MLS.com. Then, there are direct websites such as, CBRE.com and NAICapital.com, whereby sellers and buyers can access the real estate listing without an intermediary like those previously discussed.

However, while these online sites are able to present a trove of information to buyers and tenants, including pricing and availability, it is not possible for sellers or landlords, the property owners to submit a bid to buyers and tenants. In this aspect, the advantage of the presently disclosed methods is to make it possible for one or more owner member to submit a direct offer or a bid for a sale or lease to a customer member based upon one qualification file. Moreover, the presently disclosed methods can be used to supplement the previously mentioned websites and to improve volume of transactions and make the process more efficient for the owner members and customer members.

The membership club employs professional analysts to prepare a qualification package and all the information received from customer members are confidential, safe and secure on client servers and/or the cloud with the membership club management team.

Therefore, given the embodiments discussed herein the selling, leasing, renting and buying process is more efficient and direct. This method allows a customer member to receive the best offer bid from the owner members as part of the membership club. Furthermore, this method allows the owner members to efficiently complete the transaction by relying on the completed qualification package that is prepared under a uniform market standard.

The membership club with the use of a completed qualification package owner members to advertise in real time, all through a single interface and invite customer members to accept bids within a specified timeframe. The disclosed methods allow customer members to purchase and rent properties at the most competitive prices.

This real-time selling bidding or leasing bidding by owner members with the ability to connect with customer members through the membership club dramatically improves efficiency for completing sale or leasing of properties to purchase or lease. Owner members are able to transmit information or bids to customer members regarding any real estate of interest through the membership club.

Moreover, targeting customer members within a desired range has a capability to directly send its targeted advertisement to a customer member to satisfy an immediate and specific need for buying or renting real estate. Owner members can submit a text message, voice message, video, image, and digital message with a quick eye-catching advertisement to a customer member based upon criteria set forth by the customer member.

The presently disclosed methods are not to be limited in scope by the specific embodiments described herein, which are intended as single illustrations of individual aspects of the presently disclosed methods, and functionally equivalent methods and components are within the scope of the presently disclosed methods. Indeed, various modifications of the presently disclosed methods, in addition to those shown and described herein will become apparent to those skilled in the art from the foregoing description and accompanying drawings. Such modifications are intended to fall within the scope of the appended claims.

What is claimed is:

1. A method of selling or leasing real estate within a computer-based membership club, comprising the steps of:
a) establishing a real estate membership club on a website on a computer-based network, wherein the membership club comprises at least one customer member, at least two owner members, and optionally at least one credit evaluation entity;
b) on the website, accepting a real estate application package from the customer member;
c) on the website, providing access to the real estate application package to the at least two owner members;
d) on the website, accepting a bid from each of the owner members;
e) on the website, providing access to the bids to the customer member;
f) on the website, accepting the customer member's selection of the offer bid and
g) on the website, completing and closing the sale or lease transaction.

2. The method of claim 1, further comprising, after step b), the step of, on the website, providing access to real estate application package to the credit evaluation entity, and receiving the credit application evaluation results from the credit evaluation entity.

3. The method of claim 2, further comprising, after step c), the step of, on the website, creating a completed application file, comprising the real estate application package, the credit application evaluation results, and qualification package and providing access to the completed application file to the at least two owner members.

4. The method of claim 1, wherein a list of required qualification information including required documents is provided on the computer-based network by the credit evaluation entity.

5. The method of claim 2, wherein the credit application evaluation results are based on credit reports, income or any other documentation needed to close the sale or the lease.

6. The method of claim 1, wherein the real estate application package further comprises property requirements and criteria.

7. The method of claim 6, wherein the property requirements comprise at least one requirement selected from the group consisting of measurement of the property area, property amenities, and property area configuration.

8. The method of claim 1, wherein the real estate application package further comprises a desired lease term.

9. The method of claim 1, wherein the real estate application package for each customer member is stored electronically within the computer-based network with the membership club and can be accessed and updated in one or more successive transactions.

10. The method of claim 1, wherein the customer member is provided unlimited opportunity to update the real estate application package, wherein the updating comprises replacing outdated information stored electronically within the computer-based network with the membership club.

11. The method of claim 2, wherein the credit application evaluation results further comprise a qualification rating between about 1 to 10, wherein a rating of 10 represents a better qualified applicant than a rating of 1.

12. The method of claim 1, wherein the bid further comprises all the terms and conditions required to close a sale or lease transaction.

13. The method of claim 1, wherein the membership club comprises at least 1, 2, 3, 4, 5, 6, 7, 8, 9 or 10 different owner members and each owner member submits at least 1, 2, 3, 4, 5, 6, 7, 8, 9 or 10 different bids, wherein the membership club provides for a competitive bidding platform on the website.

14. The method of claim 1, wherein the customer member has a finite amount of time to select a desired bid, wherein the amount of time is less than about 7 days, 14 days, 21 days or 28 days.

15. The method of claim 1, wherein the membership club further comprises a communication platform on the website that:
i) allows owner members to advertise the bids to customer members; and/or
ii) allows customer members to advertise their criteria or requirements to buy or lease to owners members.

16. The method of claim 15, wherein the communication platform comprises a method of communication selected from the group consisting of mobile phone text messaging, telephone voice messaging, email and instant messaging over the computer-based network.

17. The method of claim 1, further comprising the steps of processing the selling and leasing transactions in compliance with state and federal regulations.
